(19) United States
(12) Patent Application Publication
(10) Pub. No.: US 2003/0164433 A1
(43) Pub. Date: Sep. 4, 2003

(54) Swivel plant hanger

(76) Inventor: Frank Junger, Avalon, NJ (US)

Correspondence Address: James D. Cashel, Esquire, MONTGOMERY, McCRACKEN, WALKER & RHOADS, LLP, 123 South Broad Street, Philadelphia, PA, 19109, US

(21) Appl. No.: 10/346,761

(22) Filed: Jan. 17, 2003

Related U.S. Application Data
(60) Provisional application No. 60/360,415, filed on Mar. 1, 2002.

(51) Int. Cl. B42F 13/00

(52) U.S. Cl. 248/339

(57) ABSTRACT

A swivel plant hanger is adapted for connection to an existing hanging basket and to provide for rotation of the basket resulting in even distribution of sunlight and uniform plant growth. In a preferred embodiment, the hanger incorporates an upper support member with a top and bottom end, a barrel swivel extending in the axial direction from the bottom end of the upper support member, and a bottom support member with a top and bottom end. The bottom support member is connected to the swivel so that, in use, a hanging plant basket can be suspended from the bottom end of the bottom support member.

### CROSS REFERENCE TO RELATED APPLICATIONS

This application claims the benefit of and priority to copending U.S. Provisional Patent entitled “‘Swiggles’; a swiveling device for hanging flower-pots, and flower baskets,” by inventor Frank Junger, filed on Mar. 1, 2002 and accorded Ser. No. 60/360,415.

U.S. Provisional Patent Ser. No. 60/360,415 is incorporated into this application by this reference.

### REFERENCE TO MICROFICHE APPENDIX

Not Applicable

### STATEMENT REGARDING FEDERALLY SPONSORED RESEARCH & DEVELOPMENT

Not Applicable

### BACKGROUND

Decorating the home, office or any other location with a hanging plant basket is commonplace. Unfortunately, in nearly all of these applications, the basket gets life-sustaining sunlight only on one side and, as a result, the plant contained in the hanging basket grows unevenly.

There have been many rotating plant hangers suggested but all involve substantial alteration to the hanging basket itself.

Consequently, it has been desirable to have an improved apparatus for hanging plant baskets which can be easily affixed to an existing hanging basket and further provide for rotation of the basket, resulting in even distribution of sunlight and uniform plant growth.

The swivel plant hanger of this invention utilizes two support members, one upper and one lower, separated by a barrel swivel. Typical support members would be chain links of some variety.

The upper support member and lower support member are connected to the swivel in a way which permits the swivel plant hanger to be affixed to an existing hanging basket, in that the upper support member can be affixed to the basket's static support and the lower support member can be affixed to the baskets existing hanger.

The swivel plant hanger can accommodate a wide range of basket sizes. For existing applications, except for potential weight limitations, the swivel plant hanger does not limit the type of basket to be hung.

The swivel plant hanger is stable, and holds the basket despite movement from wind action or watering sequences. The rotation of the swivel plant hanger also permits the plant to receive life-sustaining sunlight from all angles and thus facilitates uniform growth of the plant in the basket. The swivel plant hanger also allows for rotation of the basket to facilitate uniform watering or fertilizing.

The swivel plant hanger can also be quickly and easily installed and uninstalled for use with other baskets.

Preferably, for strength and rust resistance, the swivel plant hanger is made from polyvinyl chloride, stainless steel, plated steel or brass.

Information relevant to address the problems solved by the present invention can be found in U.S. Pat. Nos. 6,381,900; 5,329,728; 4,098,483 and 3,944,186. However, each one of these references suffers from one or more of the following disadvantages: the rotational device is not easily installed and uninstalled onto existing hanging plant baskets; the rotational device is an integral part of a new plant basket, and the rotational device would require a support different from that of the existing plant basket.

For the foregoing reasons, there is a need for a swivel plant hanger that can be easily affixed to an existing hanging basket and further provide for rotation of the basket resulting in even distribution of life-sustaining sunlight and uniform plant growth.

### SUMMARY

The present invention is directed to a swivel plant hanger that can easily be affixed to an existing hanging basket and further provide for rotation of the basket resulting in even distribution of life-sustaining sunlight and uniform plant growth.

A swivel plant hanger having features of the present invention comprises an upper support member with a top and bottom end, a barrel swivel extending in the axial direction from the bottom end of the upper support member, and a bottom support member with a top and bottom end. The bottom support member is connected to the swivel so that, in use, a hanging plant basket can be suspended from the bottom end of the bottom support member.

### BRIEF DESCRIPTION OF THE DRAWINGS

The present invention, as defined in the claims, can be better understood with reference to the following drawings. The drawings are not necessarily to scale, emphasis instead being placed on illustrating the principles of the present invention.

FIG. 1 is a perspective view of the present swivel plant hanger, showing the hanger's configuration and appearance in use with an existing hanging plant basket.

FIG. 2 is a perspective view of the present swivel plant hanger.

FIG. 3 is an elevation view of the barrel swivel used in the present swivel plant hanger.

FIG. 4 is an elevation view of a support member for the present swivel plant hanger.

FIG. 5 is an elevation view of a support member for the present swivel plant hanger.

FIG. 6 is a sectional view of a support member for the present swivel plant hanger.

### DESCRIPTION

Reference will now be made in detail to the description of the invention as illustrated in the drawings with like numerals indicating like parts throughout the several views.

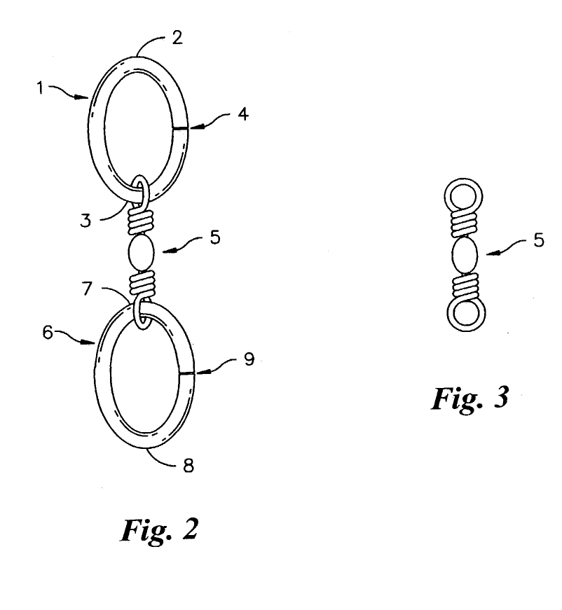

Referring to FIG. 2, a preferred embodiment of the swivel plant hanger of the present invention incorporates an upper support member 1 which includes a top end 2 and a bottom end 3. A barrel swivel 5 extends in the axial direction from the bottom end 3 of the upper support member 1. The swivel plant hanger of the present invention also incorporates a bottom support member 6 which includes a top end 7 and a bottom end 8. The top end 7 of the bottom support member 6 is connected to the barrel swivel 5 in a manner that permits a hanging plant basket to be suspended from the bottom end 8 of the bottom support member 6.

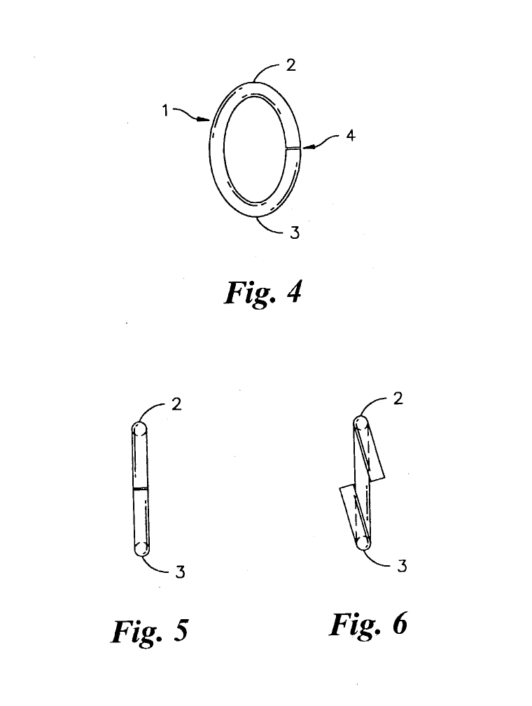

As shown in FIGS. 4 and 5, the upper support member 1 is formed by a chain link with a top end 2, a bottom end 3, and an opening 4. The formation of the bottom support member 6 is similar to that of the upper support member 1.

As shown in FIGS. 4 and 6, the opening 4 on the upper support member 1 permits the upper support member 1 to be opened and closed so that the upper support member 1 can be linked to the top end of the barrel swivel 5. As shown in FIG. 2, the bottom support member 6 also contains an opening 9 which permits the bottom support member 6 to be opened and closed so that the bottom support member 6 can be linked to the bottom end of the barrel swivel 5.

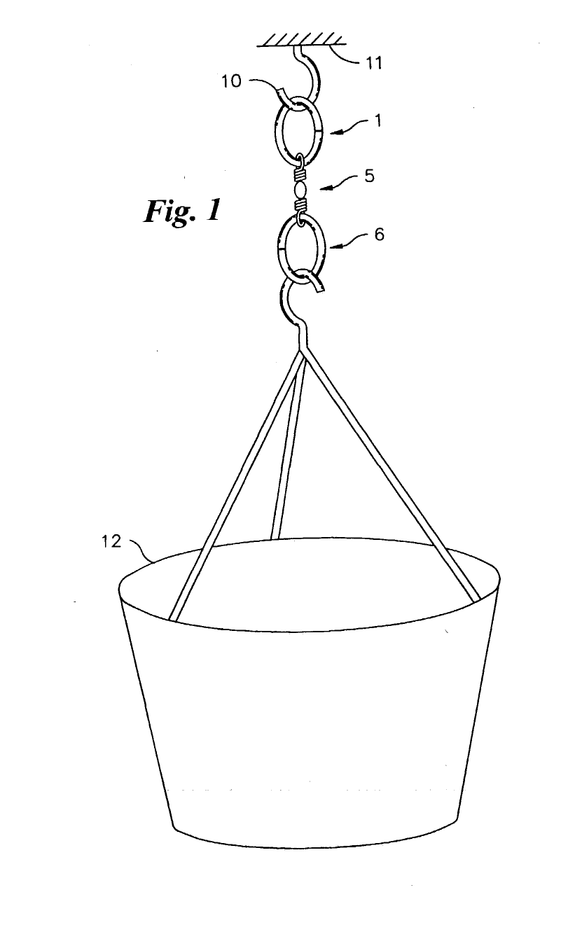

As shown in FIGS. 1 and 3, the barrel swivel 5 provides the means for rotation of bottom support member 6 without rotation of the upper support member 1. The upper support member 1 connects to the static support 10. Static support 10 is permanently affixed to a ceiling or other structural overhang 11.

Referring now to FIG. 1, the installation of the swivel plant hanger will now be described. As shown in FIG. 1, hanging plant baskets are typically suspended from a static support 10 that is permanently affixed to a ceiling or other structural overhang 11. In the present invention, the top end 2 of the upper support member 1 connects to the static support 10. The bottom end 8 of the bottom support member 6 connects to the handle of the existing hanging plant basket 12. So connected, the swivel plant hanger permits the existing hanging plant basket to rotate resulting in even distribution of life-sustaining sunlight and uniform plant growth.

The foregoing description has been presented for purposes of illustration and description. It is not intended to be exhaustive or to limit the invention to the precise forms disclosed. Obvious modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

I claim:

1. A swivel plant hanger, which comprises: an upper support member with a top and bottom end; a barrel swivel extending in the axial direction from the bottom end of the upper support member; and a bottom support member with a top and bottom end, the top end of the bottom support member being so connected to the barrel swivel that, in use, a hanging plant basket can be suspended from the bottom end of the bottom support member.

2. A swivel plant hanger according to claim 1 wherein the upper support member is a chain link.

3. A swivel plant hanger according to claim 1 wherein the bottom support member is a chain link.

4. A swivel plant hanger, according to claim 1 wherein the upper support member is a chain link and the bottom support member is a chain link.
